(19) United States
(12) Patent Application Publication
(10) Pub. No.: US 2018/0205737 A1
(43) Pub. Date: Jul. 19, 2018

(54) System and method for capturing identity related information of the link visitor in link-based sharing

(71) Applicant: Vaultize Technologies Private Limited, Pune (IN)

(72) Inventors: Ankur Panchbudhe, Pune (IN); Yusuf Batterywala, Pune (IN)

(73) Assignee: Vaultize Technologies Private Limited, Pune (IN)

(21) Appl. No.: 15/918,991

(22) Filed: Mar. 12, 2018

(51) Int. Cl. H04L 29/06

(52) U.S. Cl. CPC H04L 63/102; H04L 63/20; H04L 63/0838

(57) ABSTRACT

The embodiments herein disclose a secure means for sharing data with at least one user using a secure means for identifying and providing access to the at least one user (if authorized). Embodiments disclosed herein disclose obtaining a unique identification means (such as an email address) of a user accessing data and providing access to the user by sending an encoded link over the email address provided. Embodiments disclosed herein enable tracking the access of the data by a user using the encoded link, wherein the encoded link comprises of an email address.

### TECHNICAL FIELD

The embodiments herein relate to data sharing and, more particularly, to data sharing with at least one other user.

### BACKGROUND

Currently, sharing data by users present in a network with other users of the network, as well as with users outside the network is challenging from the perspective of users as well as an administrator of the network. The network can be an enterprise network, a network present in an organization, a personal network, a LAN (Local Area Network), a WAN (Wide Area Network), a VPN (Virtual Private Network) and so on. The users want it to be seamless and intuitive, while the administrator wants to make sure that confidential data does not fall in wrong hands and all the access is tracked. Examples of methods of sharing data with at least one other user are sending data vie email, copying, sharing a link through a message (such as email, IM (Instant Message), messaging services and so on), sharing access to data present in a server, sharing access to data present in the cloud and so on. However, current methods are unable to track who is accessing the data, when the data is being accessed, and from where (the location, the device and so on) the data is being accessed.

Current solutions use third party authentication mechanisms such as Google accounts, Facebook usernames, OpenID and so on to capture the identity of the user, who iss accessing the data. However, a user can overcome this by creating fake accounts. Another solution has the user provide a user name and password, before accessing the data. But, any user can access the data, provided he has the user name and password and there is no means to uniquely identify the user.

In the example, wherein a first user shares a link to the data with a second user (wherein the link may be a generic link or specific to the second user), the second user can share the link with a third user, wherein the third user can be an unauthorized user who does not have permission to access the data. But the third user gets access to the data, wherein the records can indicate that the second user was accessing the data, as the link can point to the second user.

### BRIEF DESCRIPTION OF THE FIGURES

The embodiments herein will be better understood from the following detailed description with reference to the drawings, in which:

FIG. 1 illustrates a network for providing access to at least one data source, according to embodiments as disclosed herein;

FIG. 2 depicts a data access controller, according to embodiments as disclosed herein;

FIG. 3 is a flowchart illustrating the process of providing a user with a link to the data, according to embodiments as disclosed herein;

FIGS. 4a and 4b are flowcharts illustrating the process of providing a user with a link to the data, according to embodiments as disclosed herein; and

FIGS. 5a and 5b are flowcharts illustrating the process of a user attempting to access the data by clicking on an encoded link, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

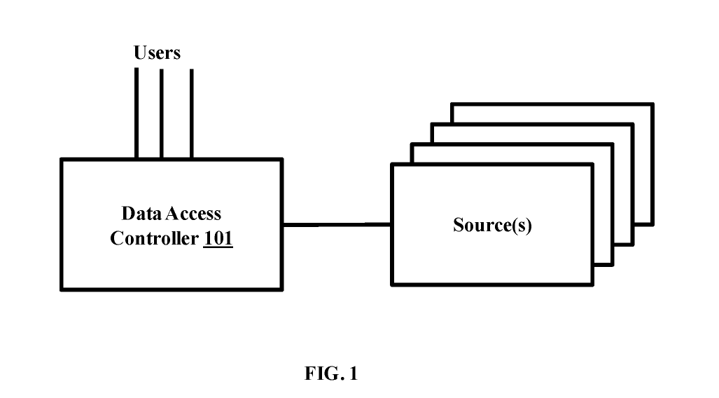

The embodiments herein disclose a secure means for sharing data with at least one user using a secure means for identifying and providing access to the at least one user (if authorized). Referring now to the drawings, and more particularly to FIGS. 1 through 5, where similar reference characters denote corresponding features consistently throughout the figures, there are shown embodiments.

Embodiments disclosed herein disclose obtaining of a unique identification means (such as an email address) of a user accessing data and providing access to the user by providing the user with an encoded link. Embodiments disclosed herein enable tracking the access of the data by a user using the encoded link, wherein the encoded link comprises of the unique identification means.

FIG. 1 illustrates a network for providing access to at least one data source, according to embodiments as disclosed herein. The system comprises of a data access controller 101. The data access controller 101 can be connected to at least one source of data. Examples of the data can be, but not limited to, information, content, software, emails, applications, application code, and so on, wherein the data can be in the form of documents (Microsoft Office Formats, PDF, Open Document formats and so on), images, media files, lists (Comma Separated values, Spreadsheets), drawings, schematics, blue-prints and so on. The source of data can comprise of at least one database, a server (such as a file server, a web server, a database server, a content management server, an application server, the Cloud, and so on), a memory and so on. The server can be any server configured to contain data; for example, a file server, a web server, a database server, a data server, a content management server and so on. The memory can be a dedicated memory device such as a hard disk, a SSD (Solid State Drive) and so on. The memory can also be a part of a device associated with the enterprise network such as a desktop, a laptop, a device belonging to the user (such as in a BYOD (Bring Your Own Device) scenario) such as a mobile phone, a tablet, a personal computing device, a computer, a laptop, a wearable computing device, an IoT (Internet of Things) device, and so on, wherein the data access controller 101 has access to the memory. The data can be in any location suitable for storing data.

At least one user such as an administrator or the owner of an account (hereinafter referred to as an administrator) can control access to the data. In an embodiment herein, the administrator can enable at least one other user to access the data. The administrator can provide a list comprising of at least one authorized user. The administrator can use at least one unique identifying means for each user such as at least one of an email address, a phone number (a PSTN (Public switched Telephone Network) number, a cellular phone number, an IP based phone number and so on), a messaging ID (such as an ID belonging to Skype, Viber, Yahoo Chat, MSN Messenger and so on), a unique ID associated with a website/app (such as Facebook, Google, Linkedin and so on), an enterprise identification means (such as an employee code) or any other equivalent means. The administrator can also assign specific rights to each of the user, such as read only, write, copy, save, download and so on.

In another embodiment herein, the administrator can enable a user to gain access to the data by providing at least one unique identifying means such as at least one of an email address, a phone number (a PSTN (Public switched Telephone Network) number, a cellular phone number, an IP based phone number and so on), a messaging ID (such as an ID belonging to Skype, Viber, Yahoo Chat, MSN Messenger and so on), a unique ID associated with a website/app (such as Facebook, Google, Linkedin and so on), an enterprise identification means (such as an employee code) or any other equivalent ID means. In an embodiment herein, the administrator can specify at least one policy, such as the email ID cannot belong to a public email service provider (such as Gmail, AOL, Yahoo, Hotmail and so on), a specific pattern of acceptable and/or unacceptable email addresses (which can be specified using wildcards and so on; for example, *@xyz.com), a set of acceptable and/or unacceptable phone numbers, a set of unacceptable IDs, a set of at least acceptable IP addresses, a set of at least one unacceptable IP addresses and so on. The administrator can further specify at least one other information to be provided by the user, before providing access to the data; such as his name, his address, his organization name and so on.

The administrator can provide the data access controller 101 with details on data and can assign a policy on a per data basis.

On a user requesting for access to a data, the data access controller 101 can request the user to provide a unique identification means (such as an email address). Embodiments herein use the email address as an example to uniquely identify the user, but it may be obvious to a person of ordinary skill in the art to use any unique identification means to identify the user. The data access controller 101 can provide the user with a uniquely generated link through a suitable means such as his email address, wherein the uniquely generated link can comprise of the email address of the user (which can be present in an encoded form or a plain form).

On the user clicking the link, the data access controller 101 verifies the email address from where the user has clicked the link. If the data access controller 101 is able to verify the email address, the data access controller 101 enables the user to access the data.

In an embodiment herein, the data access controller 101 can generate a One Time Password (OTP) on verifying the email address. The data access controller 101 can sent the OTP to the embedded email address. The data access controller 101 can prompt the user to provide the OTP. The data access controller 101 can verify the OTP and provide access to the data.

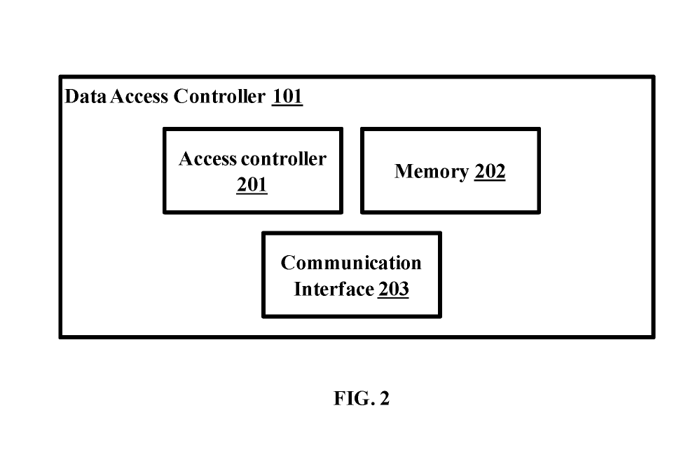

FIG. 2 depicts a data access controller, according to embodiments as disclosed herein. The data access controller 101, as depicted comprises of an access controller 201, a memory 202 and at least one communication interface 203.

The communication interface 203 can enable the data access controller 101 to communicate with at least one external entity, such as a data source and so on. The communication interface 203 can comprise of a LAN (Local Area Network) interface, a WAN (Wide Area Network) interface, IPC (Inter Process Communication), a wireless communication interface (Wi-Fi, cellular communications, Bluetooth and so on), the Internet, a private network interface and so on. The communication interface 203 can also enable the data access controller 101 to interact with other external entities such as user(s), administrator(s) and so on. The communication interface 203 can comprise of at least one of a web UI access, Application based Interface (API)-based access, FTP (File Transfer Protocol), SFTP (Secure FTP), FTPS (FTP Secure), SMTP (Simple Mail Transfer Protocol), CIFS/SMB (Common Internet File System/Server Message Block), NFS (Network File System), CIMS (Content Management Interoperability Services), ActiveSync, DAV (Distribution Authoring and Versioning), WebDAV, HTTP (Hyper Text Transfer Protocol), HTTPS (HTTP Secure) and so on.

The access controller 201 can enable the administrator to specify at least one other user to access the data. In an embodiment herein, the access controller 201 can enable the administrator to provide a list comprising of at least one authorized user by providing at least one unique identifying means for each user. The access controller 201 can enable the administrator to assign specific rights to each of the user, such as read only, write, copy, save, download and so on.

In another embodiment herein, the access controller 201 can enable the administrator to enable a user to gain access to the data by providing at least one unique identifying means. In an embodiment herein, the access controller 201 can enable the administrator to specify at least one policy. The access controller 201 can enable the administrator to further specify at least one other information to be provided by the user, before providing access to the data.

On a user requesting for access to a data, the access controller 201 can request the user to provide a unique identification means (such as an email address). In an embodiment herein, the access controller 201 can fetch the unique identification means (such as an email address) from the list of authorized user(s), as provided by the administrator (without the user requesting access to the data explicitly). The access controller 201 can encode the email address using a suitable means such as using the form of a hash or signature of the email address, a XOR of the email address and so on. The access controller 201 can then generate a link, using the encoded email address. The access controller 201 provides the user with the link using the communication interface 203, through a suitable means such as his email address.

On the user clicking the link, the access controller 201 can verify the email address from where the user has clicked the link. If the data access controller 101 is able to verify the email address, the access controller 201 can enable the user to access the data.

In an embodiment herein, the access controller 201 can generate a OTP (One Time Password), on verifying the email address. The access controller 201 can send the OTP to the embedded email address. The access controller 201 can prompt the user to provide the OTP. The access controller 201 can verify the OTP and provide access to the data.

In another embodiment herein, the access controller 201 can enable the user to enter a user editable password, wherein the user or the access controller 201 previously generated this password. On verifying the password, the access controller 201 can provide the user with access to the data.

The access controller 201 can store details of the user accessing the data, wherein the stored details can comprise of the identity of the user, the IP address from which the user is accessing the data, the time of the access, the operations performed by the user and so on.

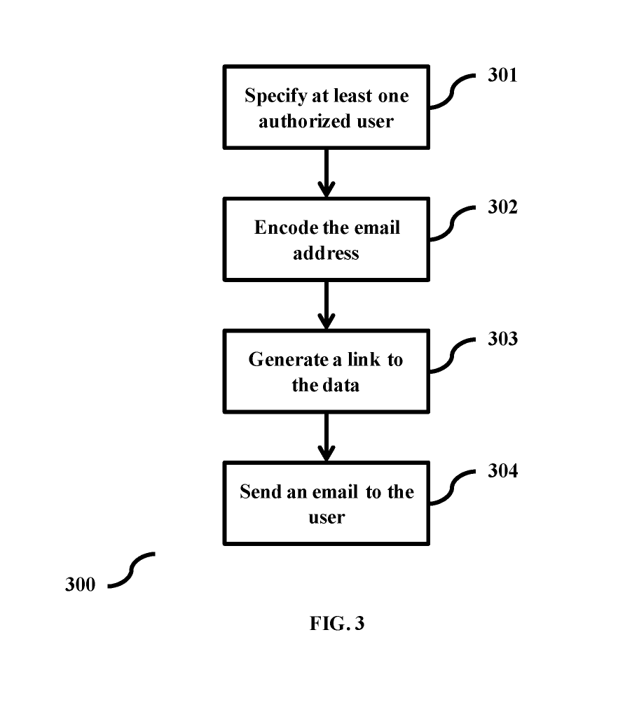

FIG. 3 is a flowchart illustrating the process of providing a user with a link to the data, according to embodiments as disclosed herein. The administrator specifies (301) at least one other user authorized to access the data and provides at least one unique identifying means for each user (such as an email). The data access controller 101 encodes (302) the email address using a suitable means such as using the form of a hash or signature of the email address, a XOR of the email address and so on. The data access controller 101 then generates (303) the link to the data, using the encoded email address. The data access controller 101 sends (304) an email to the user, wherein the email comprises of the generated link to the data. The various actions in method 300 may be performed in the order presented, in a different order or simultaneously. Further, in some embodiments, some actions listed in FIG. 3 may be omitted.

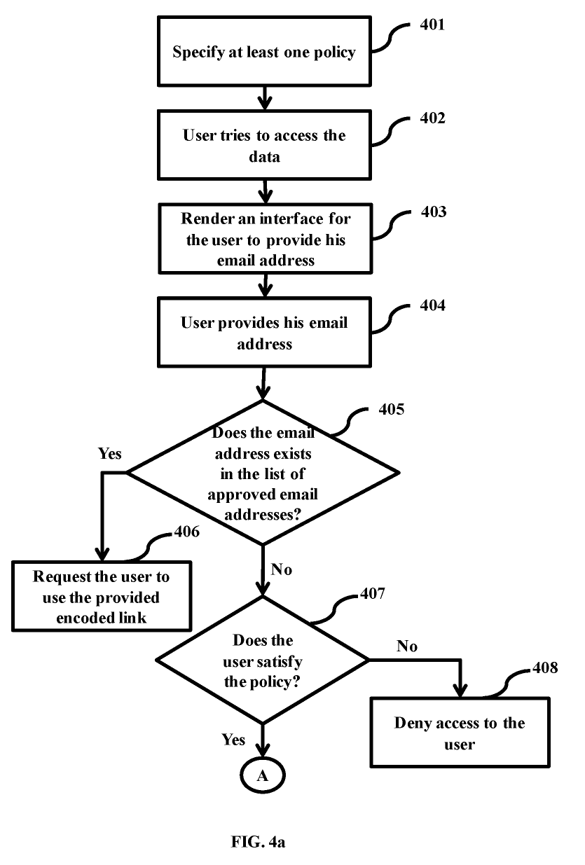

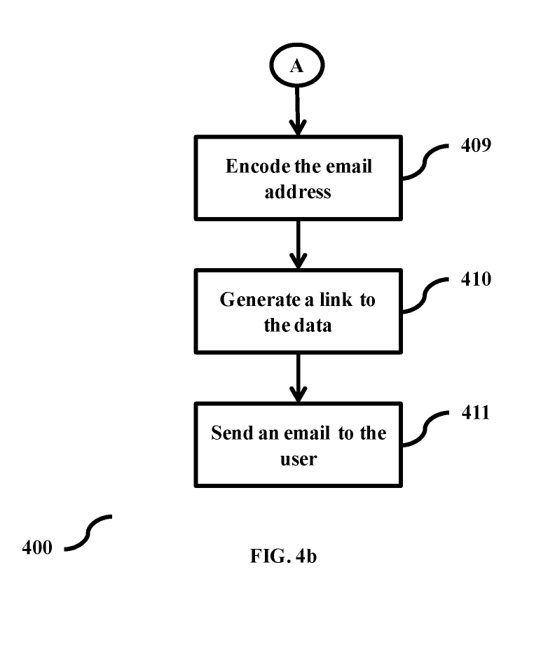

FIGS. 4a and 4b are flowcharts illustrating the process of providing a user with a link to the data, according to embodiments as disclosed herein. The administrator specifies (401) at least one policy such as the email ID cannot belong to a public email service provider (such as Gmail, AOL, Yahoo, Hotmail and so on), a specific pattern of acceptable and/or unacceptable email addresses (which can be specified using wildcards and so on; for example, *@xyz.com), a set of acceptable and/or unacceptable phone numbers, a set of unacceptable IDs, a set of at least one unacceptable IP addresses, a set of at least one acceptable geo-locations and so on. On a user trying (402) to access the data using a suitable means (such as clicking on a generic link—a link without an email address embedded in the link), the data access controller 101 renders (403) an interface (which can be a page, a pop-up, a widget and so on), wherein the user is asked to provide his email address. On the user providing (404) his email address, the data access controller 101 checks (405) if the email address exists in the list of approved email addresses, as provided by the administrator. If the email address exists in the list of approved email addresses, as provided by the administrator, the data access controller 101 requests (406) the user to use an encoded link (wherein the encoded link comprises of the encoded email address), as provided to him. If the email address does not exist in the list of approved email addresses, as provided by the administrator, the data access controller 101 further checks (407) if the user satisfies the policy, as set by the administrator (by checking the email address, IP address and so on). For example, the provided email address could belong to a public service provider, Gmail, whereas the policy specifies that the email address should not belong to a public service provider and hence the provided email address does not satisfy the policy. In another example, the user provides an email address acme123@acme.com (wherein acme is the name of an organization), where the policy states that only email addresses from the domain name acme.com are acceptable and hence the provided email address satisfies the policy. In another example, the user provides an email address acme@acme123.com (wherein acme123 is the name of an organization), where the policy states that only email addresses from the domain name acme.com are acceptable and hence the provided email address does not satisfy the policy. In another example, the user provides an email address acme123@acme.com, where this email address is not present in the list of acceptable email addresses as mentioned in the policy and hence the provided email address does not satisfy the policy. In another example, the user is attempting to access the data using an IP address 271.200.191.54; whereas the policy states that only IP addresses from the range 271.200.100.* are acceptable and hence the policy is not satisfied. If the policy is not satisfied, the data access controller 101 denies (408) access to the user. If the policy is satisfied, the data access controller 101 encodes (409) the email address using a suitable means such as using the form of a hash or signature of the email address, a XOR of the email address and so on. The data access controller 101 then generates (410) the link to the data, using the encoded email address. The data access controller 101 sends (411) an email to the user, wherein the email comprises of the generated link to the data. The various actions in method 400 may be performed in the order presented, in a different order or simultaneously. Further, in some embodiments, some actions listed in FIGS. 4a and 4b may be omitted.

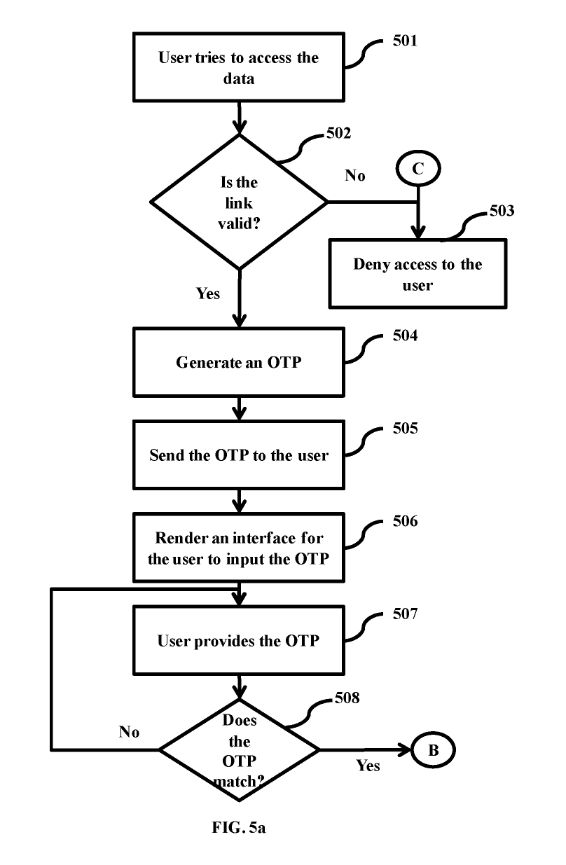

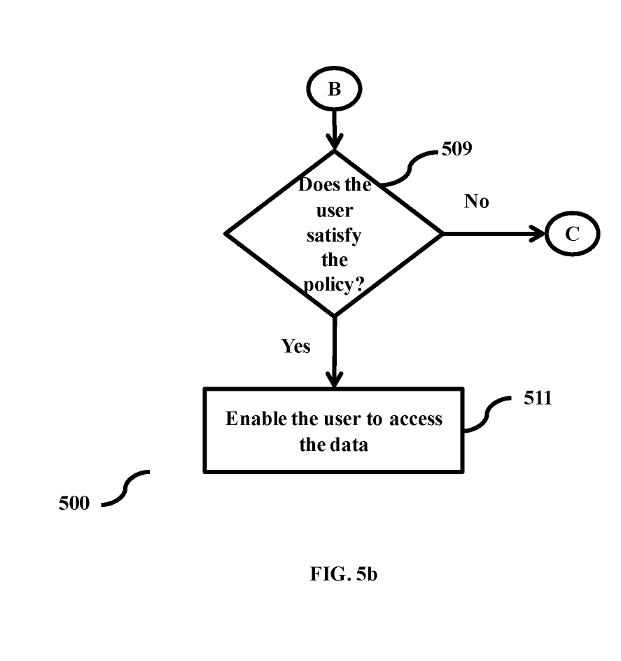

FIGS. 5a and 5b are flowcharts illustrating the process of a user attempting to access the data by clicking on an encoded link, according to embodiments as disclosed herein. On a user requesting (501) for access to a data by clicking on an encoded link, the data access controller 101 checks (502) if the link is valid. The data access controller 101 can check if the link is valid by checking if there is an encoded email address present in the link. The data access controller 101 can further check if the link is valid by checking if the email address from which the user clicked on the link is the same as the email address encoded in the encoded link. If the link is not valid, the data access controller 101 denies (503) the user access to the data. If the link is valid, the data access controller 101 generates (504) the OTP and sends (505) the OTP to the email address, as present in the encoded link. The data access controller 101 further renders (506) an interface for the user to input the OTP, wherein the interface can be at least one of a web page, a pop-up, widget and so on. On the user providing (507) the OTP, the data access controller 101 checks (508) if the OTP matches. If the OTP does not match, the data access controller 101 provides the user another opportunity to provide the OTP again. The user can attempt to enter the OTP for a pre-defined number of times, as defined by the administrator, and on the user not entering the OTP correctly within the pre-defined number of time, the data access controller 101 can deny access to the user. On the user entering the correct OTP, the data access controller 101 checks (509) if the user satisfies the policy, as set by the administrator (such as the IP address of the user being acceptable and so on). If the user does not satisfy the policy, the data access controller 101 denies (503) the user the access to the data. If the user satisfies the policy, the data access controller 101 enables (510) the user to access the data. The various actions in method 500 may be performed in the order presented, in a different order or simultaneously. Further, in some embodiments, some actions listed in FIGS. 5a and 5b may be omitted.

Embodiments herein use an email address merely as an example of a unique means of identifying a user. However, it may be obvious to a person of ordinary skill in the art to use any other suitable unique identification means such as a phone number (a PSTN (Public switched Telephone Network) number, a cellular phone number, an IP based phone number and so on), a messaging ID (such as an ID belonging to Skype, Viber, Yahoo Chat, MSN Messenger and so on), a unique ID associated with a website/app (such as Facebook, Google, Linkedin and so on) or any other equivalent means to identify the user.

Embodiments herein use the email address merely as an example means of communicating the encoded link to the user. It may be obvious to a person of ordinary skill in the art to use any other equivalent means to communicate the encoded link to the user, such as a chat, an Instant Messaging (IM) session, a mobile message (Short Messaging Service (SMS) and so on) or any other equivalent means.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for enabling at least one user to access data by a data access controller, the method comprising
checking if a link clicked by the user to access the data is valid by the data access controller, wherein the data access controller generates a valid link by
encoding a unique identification means of the at least one user;
generating a link to the data, wherein the generated link comprises of the encoded unique identification means; and
sharing the generated link with the at least one user;
verifying a password provided by the at least one user by the data access controller, on the data access controller detecting that the link is valid;
checking if the user satisfies all policies by the data access controller, on the data access controller verifying the password; and
enabling the user to access data by the data access controller, if the user satisfies all policies.

2. The method, as claimed in claim 1, wherein an administrator provides the unique identification means to the data access controller.

3. The method, as claimed in claim 1, wherein the at least one user provides the unique identification means to the data access controller, wherein the method further comprises of
checking if the unique identification means is a valid unique identification means by the data access controller; and
checking if the at least one user satisfies all policies by the data access controller, if the unique identification means is a valid unique identification means .

4. The method, as claimed in claim 1, wherein the password is a One Time Password (OTP) provided to the user by the data access controller, on verifying that the link is a valid link.

5. The method, as claimed in claim 1, wherein the password is a user editable password.

6. A system for enabling at least one user to access data, the system configured for
checking if a link clicked by the user to access the data is valid, wherein the system is configured for generating a valid link by
encoding a unique identification means of the at least one user;
generating a link to the data, wherein the generated link comprises of the encoded unique identification means ; and
sharing the generated link with the at least one user;
verifying a password provided by the at least one user, on detecting that the link is valid;
checking if the user satisfies all policies, on verifying the password; and
enabling the user to access data, if the user satisfies all policies.

7. The system, as claimed in claim 6, wherein an administrator provides the unique identification means.

8. The system, as claimed in claim 6, wherein the at least one user provides the unique identification means , wherein the device is further configured for
checking if the unique identification means is a valid unique identification means by the data access controller; and
checking if the at least one user satisfies all policies by the data access controller, if the unique identification means is a valid unique identification means.

9. The system, as claimed in claim 6, wherein the system is configured for providing a One Time Password (OTP) as the password to the user, on verifying that the link is a valid link.

10. The system, as claimed in claim 6, wherein the password is a user editable password.
